(19) United States
(12) Patent Application Publication
(10) Pub. No.: US 2021/0226383 A1
(43) Pub. Date: Jul. 22, 2021

(54) CONNECTOR

(71) Applicant: Yazaki Corporation, Tokyo (JP)

(72) Inventor: Akihiro Saito, Shizuoka (JP)

(21) Appl. No.: 17/137,354

(22) Filed: Dec. 30, 2020

(30) Foreign Application Priority Data
Jan. 16, 2020 (JP) 2020-005004

(51) Int. Cl. H01R 13/627

(52) U.S. Cl. CPC H01R 13/6275; H01R 13/6272

(57) ABSTRACT

A connector includes a sensing member inserted into the second housing along the first direction, and a sensing mechanism allowing the sensing member to advance to a predetermined engaged position along the first direction when the first housing and the second housing are completely fitted, and locking the sensing member at a position before the engaged position when the first housing and the second housing are not completely fitted. The sensing member includes an exposed portion exposed to an outer space when the sensing member is in the engaged position. In the exposed portion, a first surface exposed to a side opposite to a side of a central axis of the second housing is an inclined surface or an arc-shaped surface extending in a direction inclined with respect to the first direction and facing a side opposite to a side of the first housing in the first direction.

### CROSS-REFERENCE TO RELATED APPLICATION(S)

The present application claims priority to and incorporates by reference the entire contents of Japanese Patent Application No. 2020-005004 filed in Japan on Jan. 16, 2020.

### BACKGROUND OF THE INVENTION

### 1. Field of the Invention

The present invention relates to a connector.

### 2. Description of the Related Art

In conventional art, there are connectors including sensing members. Japanese Patent Application Laid-open No. 2002-141145 discloses a connector in which one of a pair of connector housings that can be mutually fitted is provided with a lock arm and a sensing member.

Some connectors require a structure that prohibits extraction of the sensing member without using a tool. For example, to meet a safety standard, a structure that does not allow the extraction of the sensing member with fingers may be required.

### SUMMARY OF THE INVENTION

An object of the present invention is to provide a connector configured to prevent extraction of the sensing member with fingers.

In order to solve the above mentioned problem and achieve the object, a connector according to one aspect of the present invention includes a first housing; a second housing that is fitted into the first housing along a first direction; a sensing member that is inserted into the second housing along the first direction; and a sensing mechanism that allows the sensing member to advance to a predetermined engaged position along the first direction when the first housing and the second housing are completely fitted, and locking the sensing member at a position before the engaged position when the first housing and the second housing are not completely fitted, wherein the sensing member includes an exposed portion positioned in an end portion of the sensing member and exposed to an outer space when the sensing member is in the engaged position, and in the exposed portion, a first surface exposed to a side opposite to a side of a central axis of the second housing is an inclined surface or an arc-shaped surface extending in a direction inclined with respect to the first direction and facing a side opposite to a side of the first housing in the first direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a connector according to an embodiment;

FIG. 2 is an exploded perspective view of the connector according to the embodiment;

FIG. 3 is a perspective view of a first housing according to the embodiment;

FIG. 4 is a front view of the first housing according to the embodiment;

FIG. 5 is a cross-sectional perspective view of the first housing according to the embodiment;

FIG. 6 is a perspective view of a second housing according to the embodiment;

FIG. 7 is a front view of the second housing according to the embodiment;

FIG. 8 is a cross-sectional view of the second housing according to the embodiment;

FIG. 9 is a perspective view of a sensing member according to the embodiment;

FIG. 10 is a plan view of the sensing member according to the embodiment;

FIG. 11 is a side view of the sensing member according to the embodiment;

FIG. 12 is a perspective view of the sensing member according to the embodiment;

FIG. 13 is a perspective view illustrating the sensing member inserted into the second housing;

FIG. 14 is a perspective view illustrating the sensing member in a temporary locked position;

FIG. 15 is a cross-sectional perspective view illustrating the second housing and the sensing member inserted toward a complete fitted position;

FIG. 16 is a cross-sectional view illustrating the sensing member in an engaged position;

FIG. 17 is a cross-sectional view illustrating the sensing member in the engaged position;

FIG. 18 is a perspective view illustrating a release operation with a jig;

FIG. 19 is a plan view illustrating the sensing member in the engaged position; and

FIG. 20 is a cross-sectional view illustrating force along a first direction.

### DETAILED DESCRIPTION OF THE PREFERRED EMBODIMENTS

A connector according to an embodiment of the present invention will now be described hereinafter in detail with reference to drawings. The present invention is not limited to the embodiment. Constituent elements in the following embodiment include elements that the skilled person can easily conceive or substantially the same elements.

### Embodiment

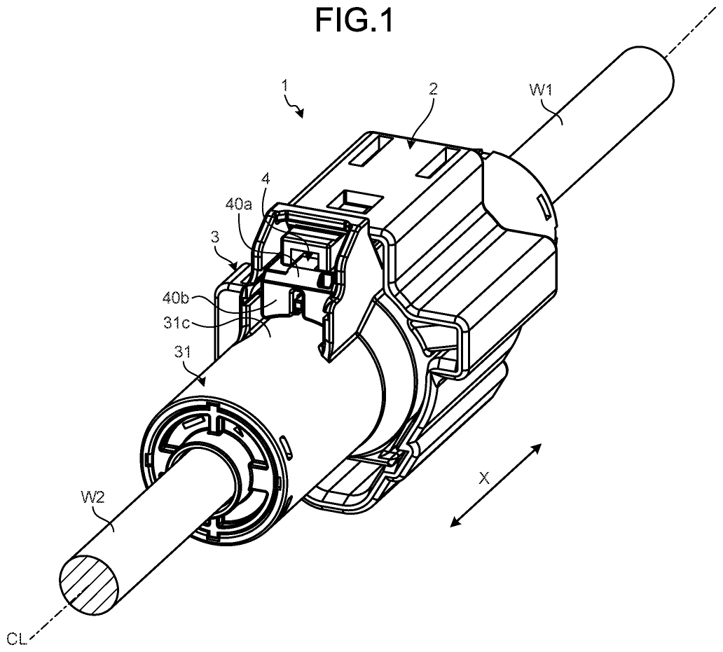

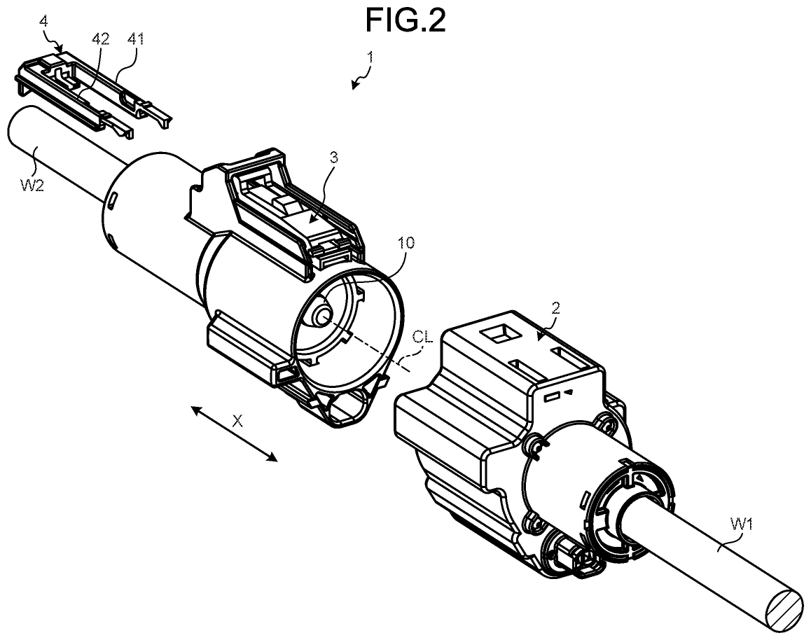

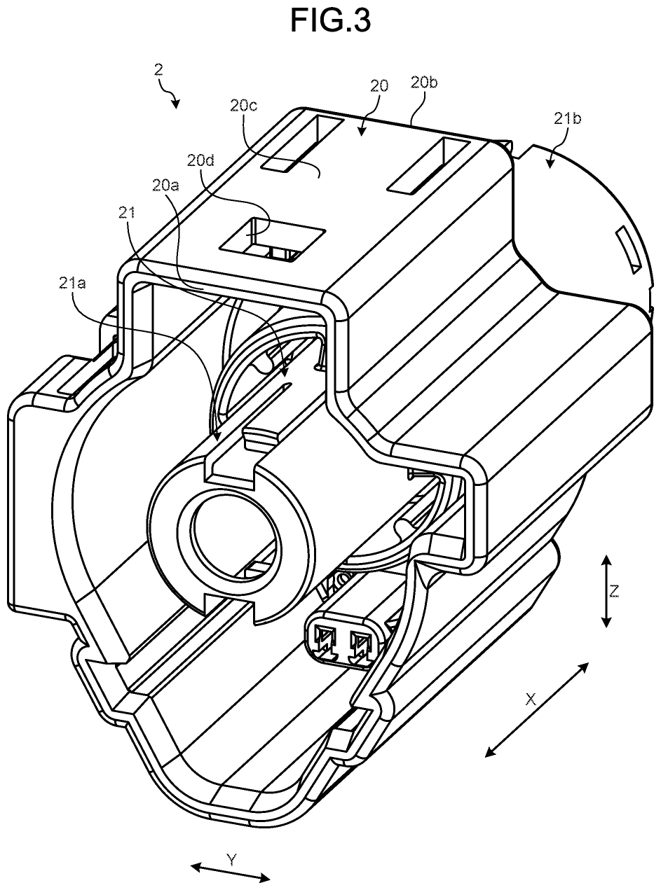

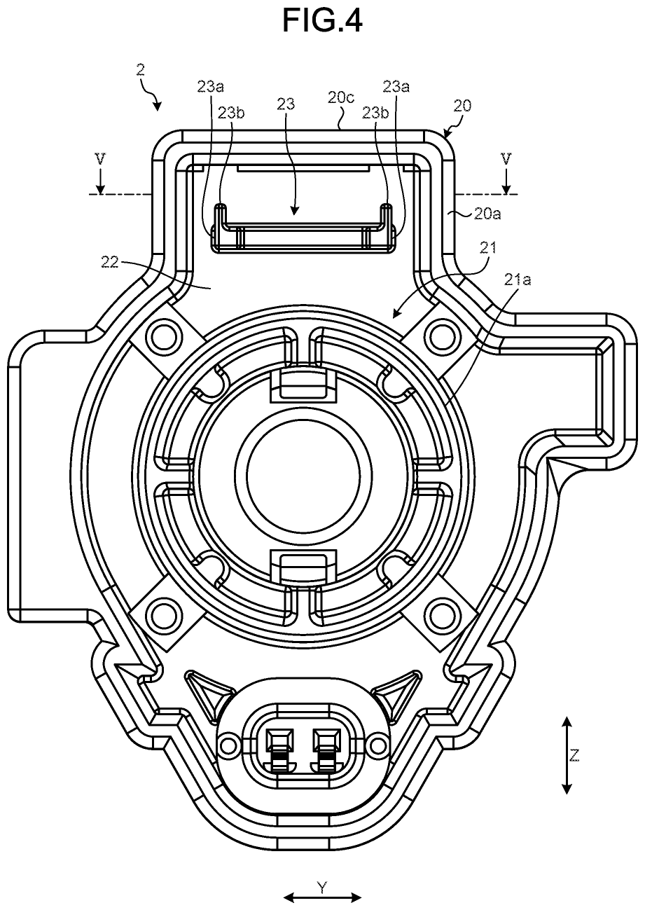

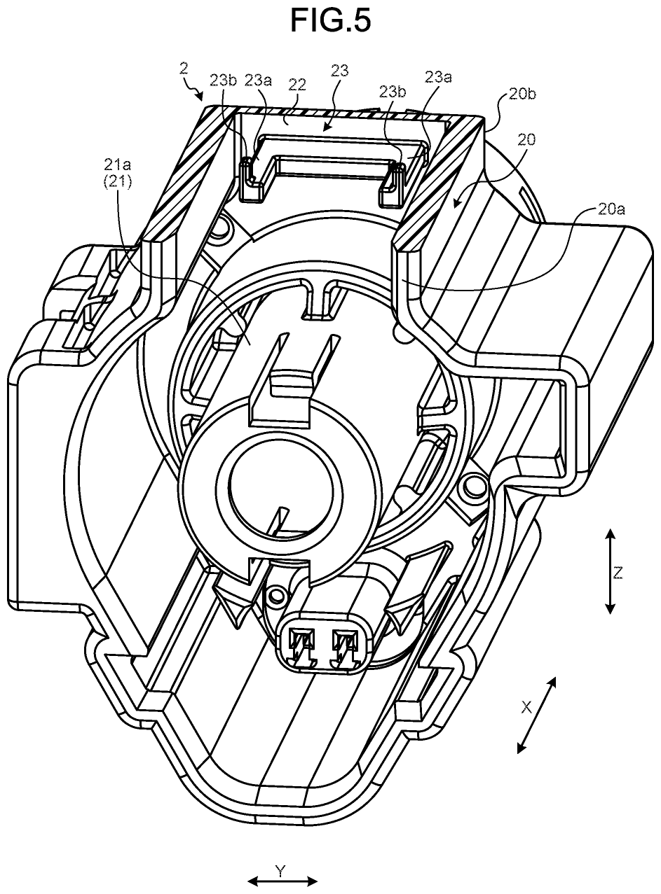

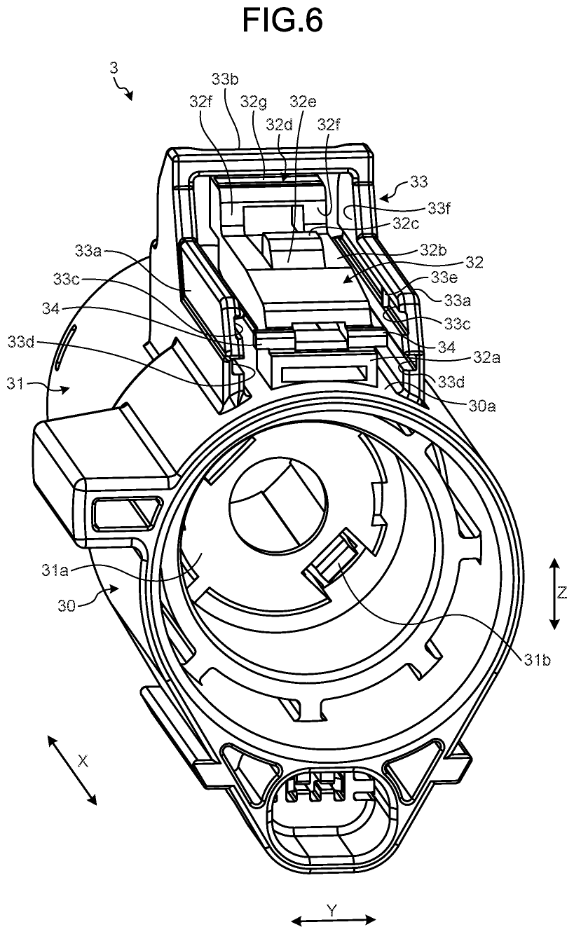

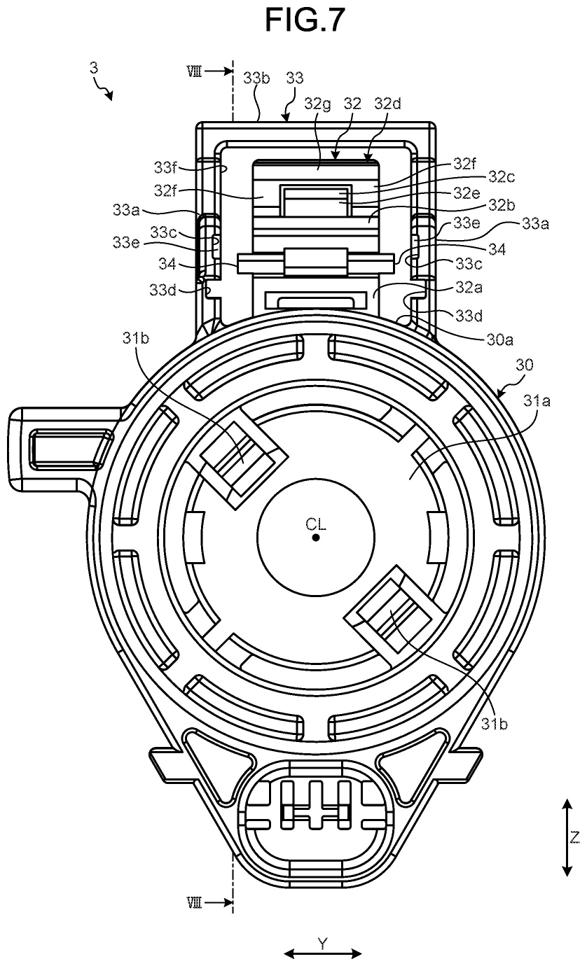

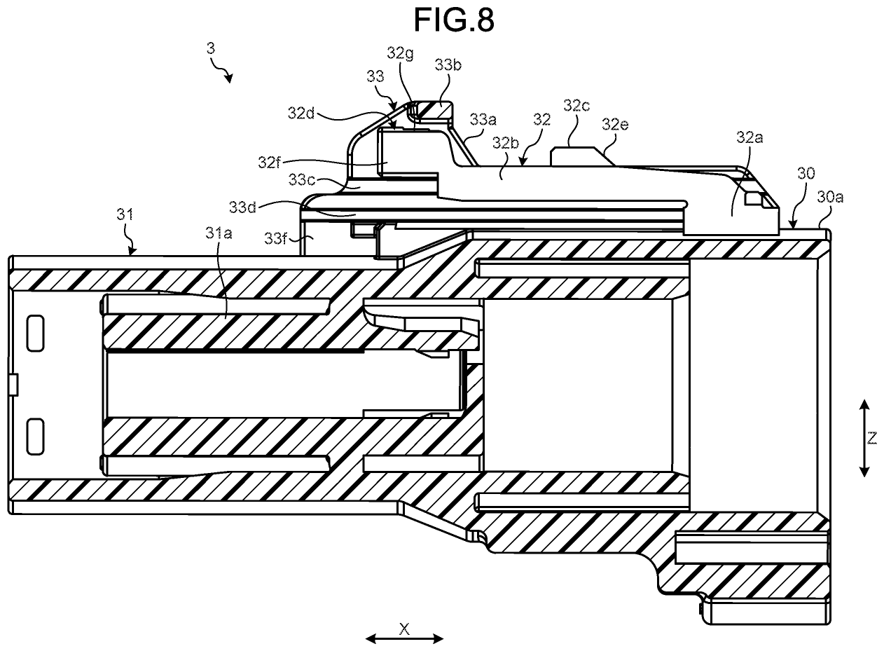

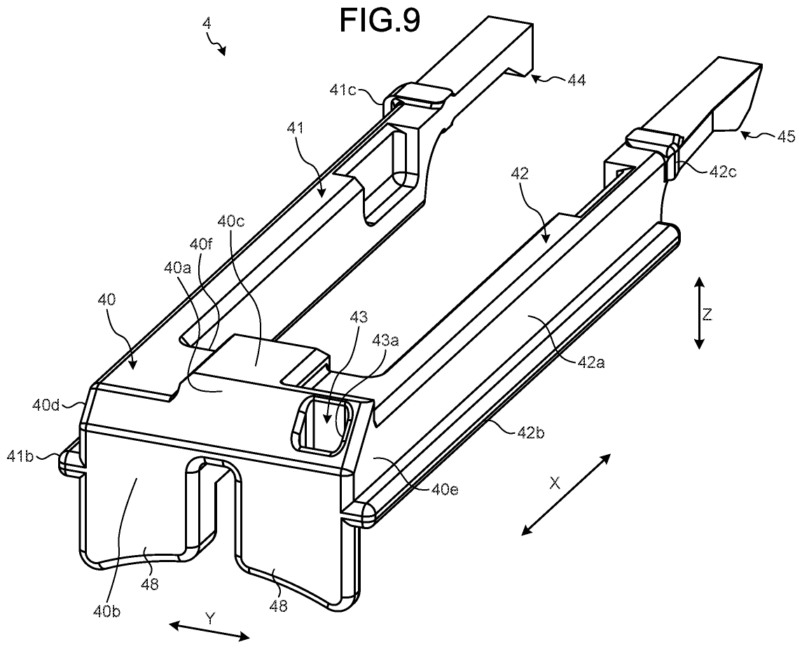

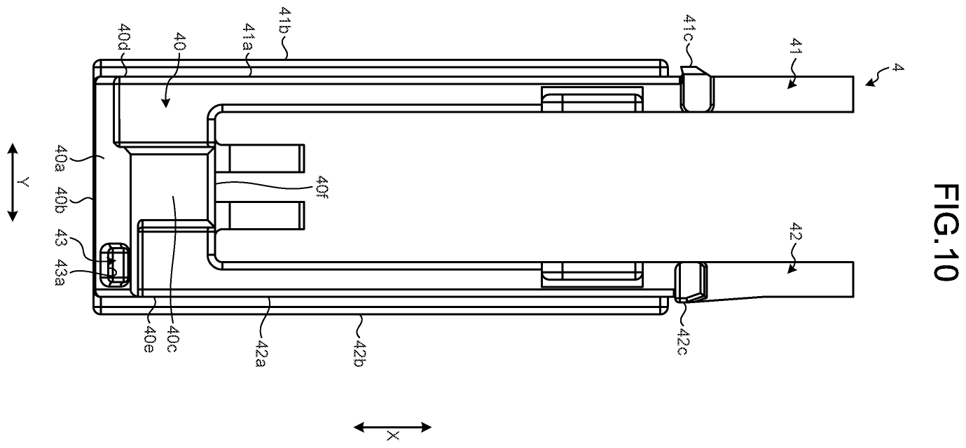

An embodiment will be explained with reference to FIG. 1 to FIG. 20. The present embodiment relates to a connector. FIG. 1 is a perspective view of a connector according to the embodiment, FIG. 2 is an exploded perspective view of the connector according to the embodiment, FIG. 3 is a perspective view of a first housing according to the embodiment, FIG. 4 is a front view of the first housing according to the embodiment, FIG. 5 is a cross-sectional perspective view of the first housing according to the embodiment, FIG. 6 is a perspective view of a second housing according to the embodiment, FIG. 7 is a front view of the second housing according to the embodiment, FIG. 8 is a cross-sectional view of the second housing according to the embodiment, FIG. 9 is a perspective view of a sensing member according to the embodiment, and FIG. 10 is a plan view of the sensing member according to the embodiment.

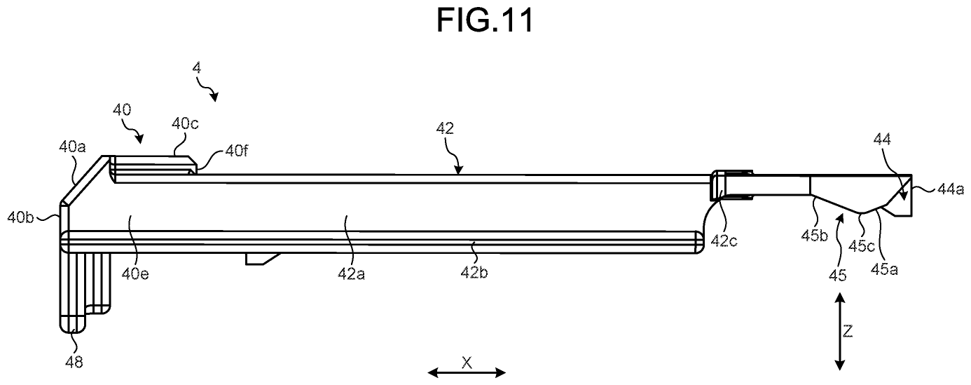

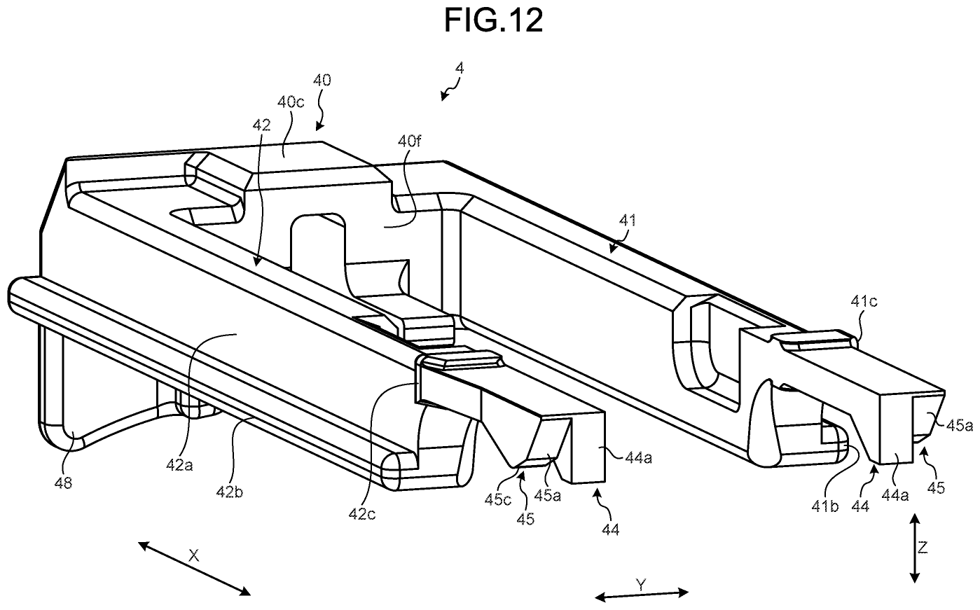

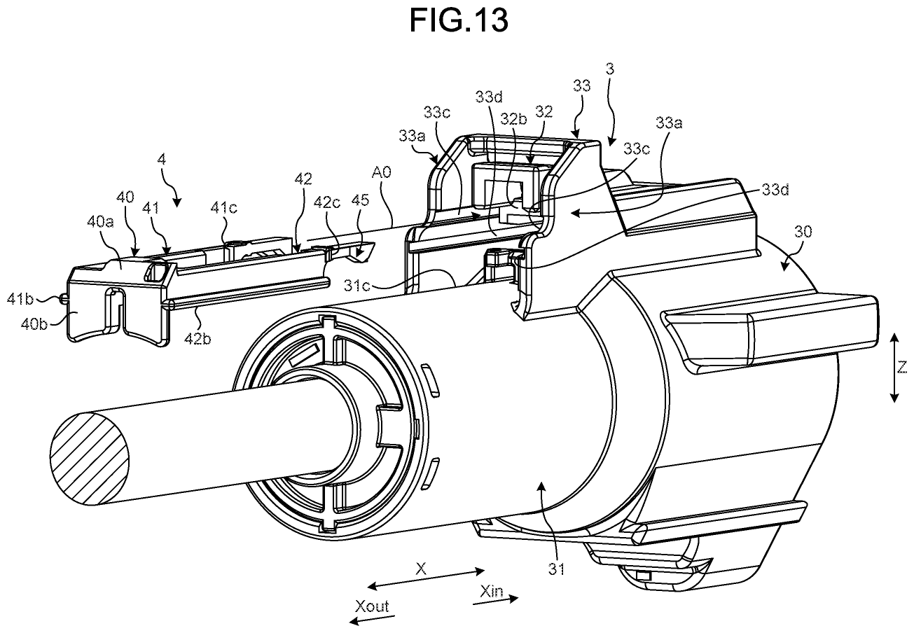

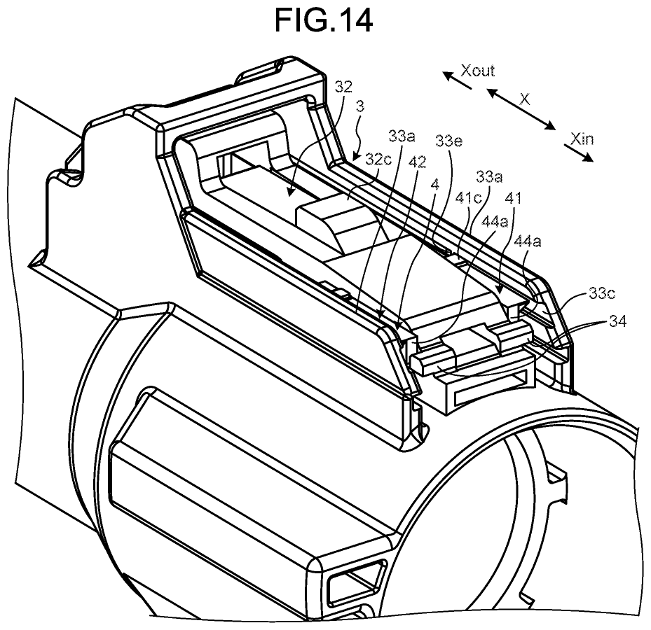

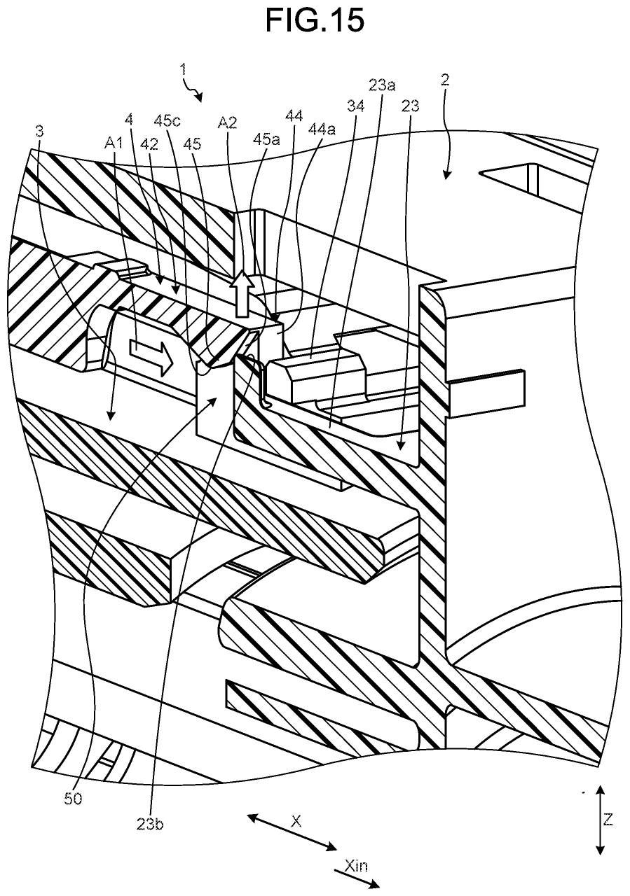

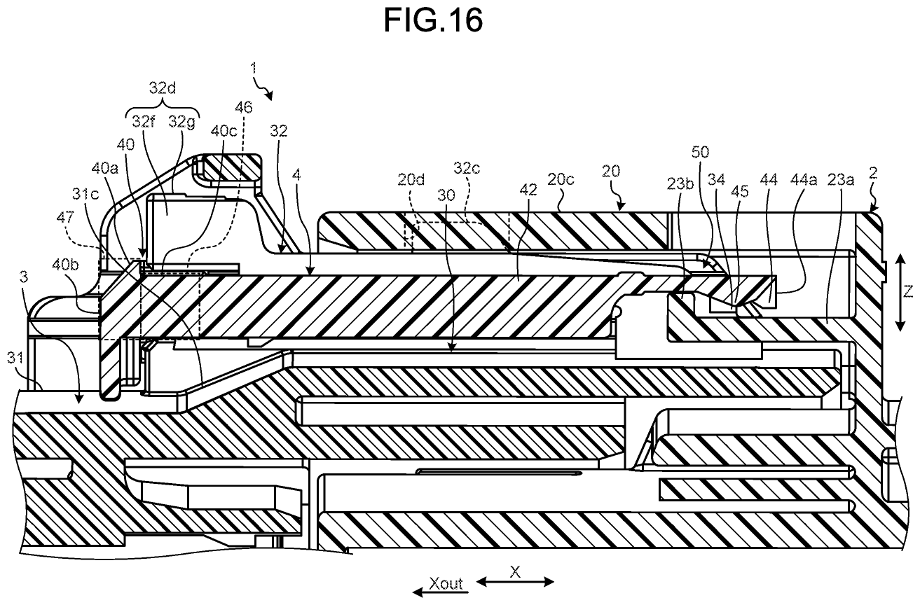

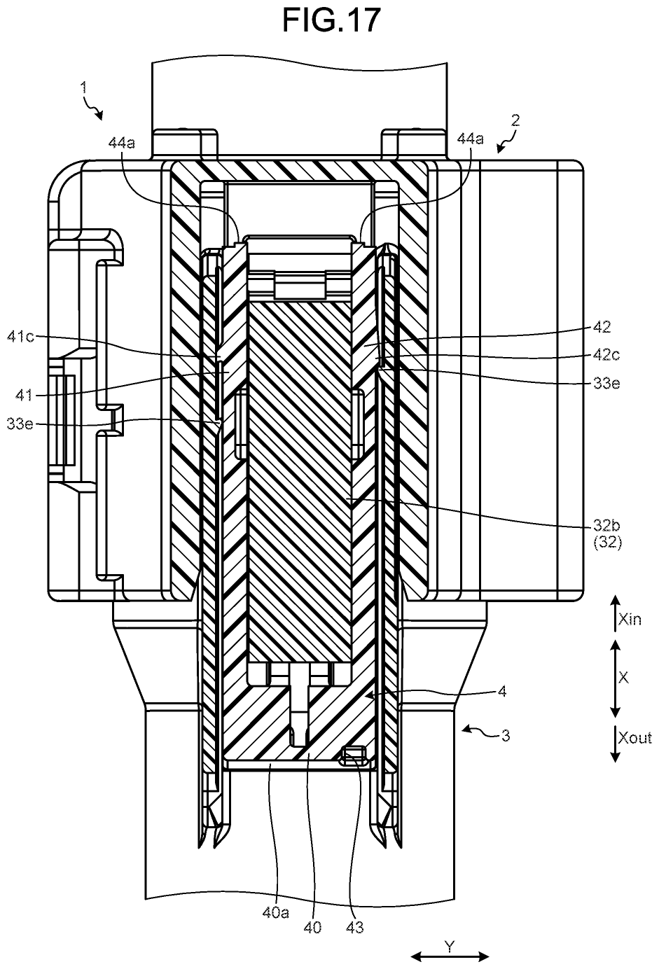

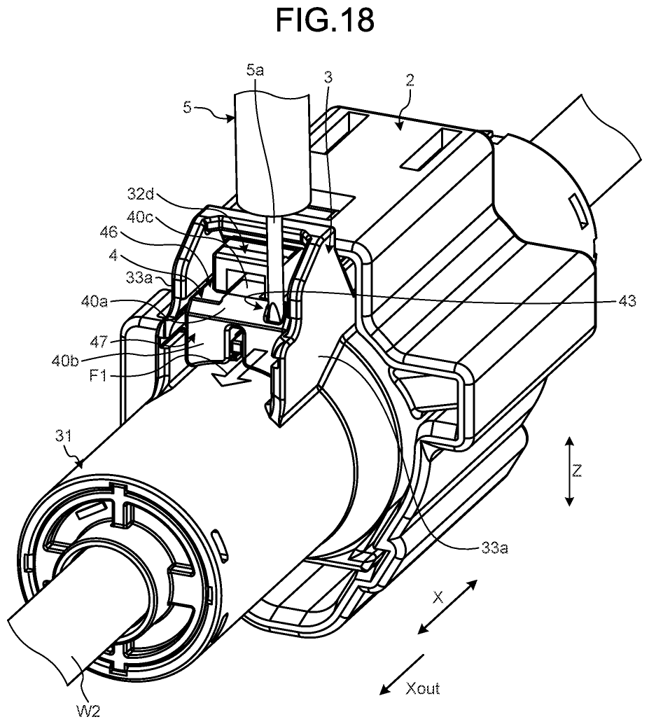

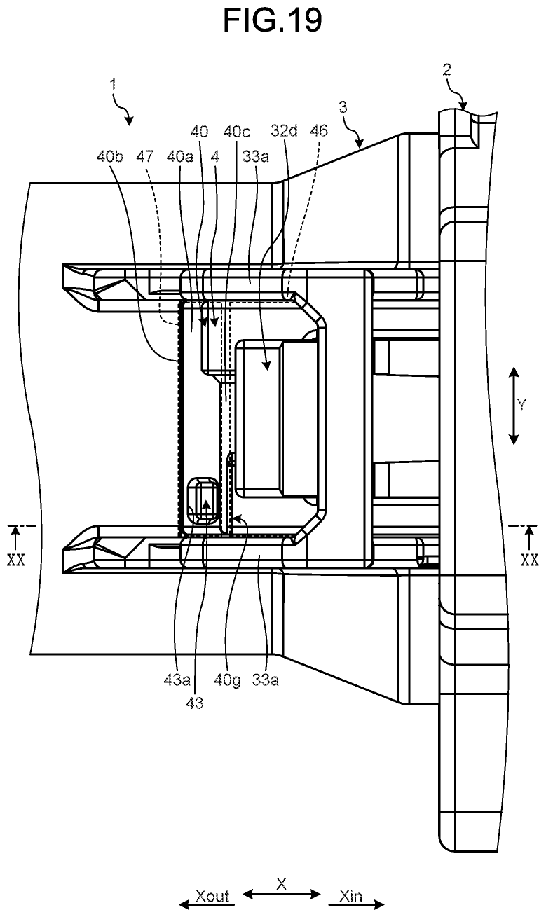

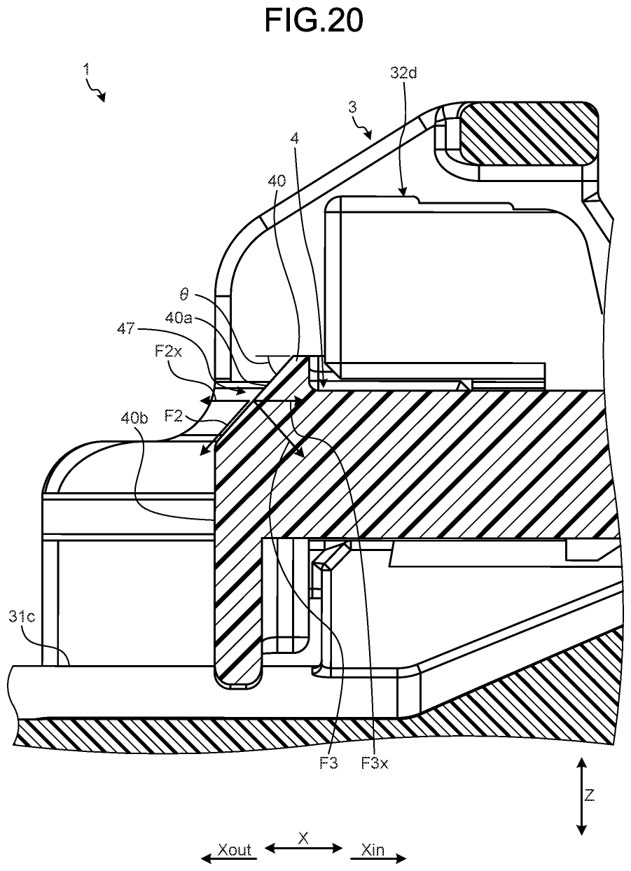

FIG. 11 is a side view of the sensing member according to the embodiment, FIG. 12 is a perspective view of the sensing member according to the embodiment, FIG. 13 is a perspective view illustrating the sensing member inserted into the second housing, FIG. 14 is a perspective view illustrating the sensing member in a temporary locked position, FIG. 15 is a cross-sectional perspective view illustrating the second housing and the sensing member inserted toward a complete fitted position, FIG. 16 is a cross-sectional view illustrating the sensing member in an engaged position, FIG. 17 is a cross-sectional view illustrating the sensing member in the engaged position, FIG. 18 is a perspective view illustrating a release operation with a jig, FIG. 19 is a plan view illustrating the sensing member in the engaged position, and FIG. 20 is a cross-sectional view illustrating force along a first direction. FIG. 4 illustrates a V-V cross section in FIG. 5. FIG. 8 illustrates a VIII-VIII cross section in FIG. 7. FIG. 20 illustrates a XX-XX cross section in FIG. 19. The cross-sectional positions of FIG. 15 and FIG. 16 are the same as the cross-sectional position of FIG. 20.

As illustrated in FIG. 1 and FIG. 2, a connector 1 according to the present embodiment includes a first housing 2, a second housing 3, and a sensing member 4. The connector 1 electrically connects a first electrical wire W1 with a second electrical wire W2. In the present embodiment, the first housing 2 is an outer housing, and a second housing 3 is an inner housing. The first housing 2 retains a terminal connected with the first electrical wire W1. The second housing 3 retains a terminal 10 connected with the second electrical wire W2. The illustrated terminal 10 is a male terminal. The first housing 2 retains a female terminal corresponding to the terminal 10.

The second housing 3 is fitted into the first housing 2 along a first direction X. The first direction X is an axial direction of the first housing 2 and the second housing 3. With complete fitting of the first housing 2 with the second housing 3, the first electrical wire W1 and the second electrical wire W2 are electrically connected. In the following explanation, a state in which the first housing 2 and the second housing 3 are completely fitted is referred to as “complete fitted state”. In addition, a state in which the first housing 2 and the second housing 3 are partially fitted but do not reach the complete fitted state is referred to as “incomplete fitted state”.

The sensing member 4 is a member sensing whether the first housing 2 and the second housing 3 are in the complete fitted state. The sensing member 4 is inserted into the second housing 3 to a temporary locked position. The second housing 3 is fitted into the first housing 2, in a state of retaining the sensing member 4. In the complete fitted state, the sensing member 4 can be inserted from the temporary locked position into a predetermined engaged position. By contrast, in the incomplete fitted state, the sensing member 4 is locked at the temporary locked position before the engaged position. In other words, in the incomplete fitted state, the sensing member 4 is not allowed to advance to the engaged position.

The sensing member 4 in the engaged position disables a release operation for the complete fitted state. When a worker wishes to release the complete fitted state, the worker is required to extract the sensing member 4 from the engaged position. The connector 1 according to the present embodiment is designed to use a jig (tool) for an operation of extracting the sensing member 4 from the engaged position. As explained in detail hereinafter, the connector 1 is configured such that an operation of extracting the sensing member 4 is substantially impossible or difficult even when the worker attempts to extract the sensing member 4 with his/her fingers.

As illustrated in FIG. 3 to FIG. 5, the first housing 2 includes an outer cylindrical portion 20, an inner cylindrical portion 21, a partition portion 22, and a guide portion 23. The outer cylindrical portion 20, the inner cylindrical portion 21, the partition portion 22, and the guide portion 23 are formed of, for example, insulating synthetic resin and as one unitary piece. Each of the outer cylindrical portion 20 and the inner cylindrical portion 21 has a cylindrical shape. The outer cylindrical portion 20 is a portion forming an outer shell of the first housing 2. The outer cylindrical portion 20 includes a first end portion 20a and a second end portion 20b. The first end portion 20a is one end portion in the first direction X. The first end portion 20a is opened in the first direction X. The second housing 3 is inserted into the outer cylindrical portion 20 through the first end portion 20a. The second end portion 20b is the other end portion in the first direction X.

The inner cylindrical portion 21 has a circular cross section. The inner cylindrical portion 21 includes a first cylindrical portion 21a retaining the female terminal, and a second cylindrical portion 21b through which the first electrical wire W1 is inserted. The partition portion 22 connects the second end portion 20b of the outer cylindrical portion 20 with the inner cylindrical portion 21. The partition portion 22 is orthogonal to the first direction X, and divides the inner space of the outer cylindrical portion 20 from the outer space. The first cylindrical portion 21a projects from the partition portion 22 to the inner space of the outer cylindrical portion 20. The second cylindrical portion 21b projects from the partition portion 22 along the first direction X toward a side opposite to the side of the first cylindrical portion 21a.

The guide portion 23 has a function of guiding the sensing member 4 to the engaged position. The guide portion 23 projects from the partition portion 22 along the first direction X toward the inner space of the outer cylindrical portion 20. The guide portion 23 includes two column portions 23a. The two column portions 23a are mutually opposed in a second direction Y. The second direction Y is a direction orthogonal to the first direction X. A distal end of each of the column portions 23a is provided with a guide projection 23b projecting in a third direction Z. The third direction Z is a direction orthogonal to both of the first direction X and the second direction Y. The third direction Z is a height direction of the connector 1.

The outer cylindrical portion 20 includes a bulging portion 20c. The bulging portion 20c is positioned at an end portion of the outer cylindrical portion 20 in the third direction Z. The bulging portion 20c bulges in a direction of extending away from the first cylindrical portion 21a to form a storing space having a substantially rectangular cross section. The sensing member 4 and an arm 32 of the second housing 3 are stored inside the bulging portion 20c. The bulging portion 20c is provided with an engagement hole 20d. The engagement hole 20d pierces a wall of the bulging portion 20c along the third direction Z.

As illustrated in FIG. 6 to FIG. 8, the second housing 3 includes a first cylindrical portion 30, a second cylindrical portion 31, an arm 32, and a guide portion 33. The first cylindrical portion 30, the second cylindrical portion 31, the arm 32, and the guide portion 33 are formed of, for example, insulating synthetic resin and as one unitary piece. Each of the first cylindrical portion 30 and the second cylindrical portion 31 has a cylindrical shape. The second cylindrical portion 31 projects from an end portion of the first cylindrical portion 30 along the first direction X. An outer diameter of the second cylindrical portion 31 is smaller than an outer diameter of the first cylindrical portion 30.

The first cylindrical portion 30 is a portion fitted into the first housing 2. A cylindrical retaining portion 31a retaining the terminal 10 is provided inside the second cylindrical portion 31. The retaining portion 31a includes engagement portions 31b engaged with the first cylindrical portion 21a of the first housing 2.

The arm 32 includes an engagement projection 32c having flexibility and engaged with the engagement hole 20d of the first housing 2. The arm 32 includes a base portion 32a, a main member 32b, the engagement projection 32c, and an operating portion 32d. The base portion 32a is connected with an outer circumferential surface 30a of the first cylindrical portion 30, and projects from the outer circumferential surface 30a in the third direction Z. The base portion 32a has a substantially rectangular parallelepiped shape with the second direction Y serving as the longitudinal direction. The base portion 32a includes a pair of locking portions 34. The locking portions 34 project in the second direction Y. The locking portions 34 have a columnar or plate shape. The locking portions 34 lock the sensing member 4 at the temporary locked position.

The main member 32b of the arm 32 extends from the base portion 32a toward the second cylindrical portion 31 along the first direction X. The arm 32 has elasticity enabling deflective deformation. The main member 32b has a plate shape with the second direction Y serving as the width direction. A gap enabling deflective deformation of the main member 32b is provided between the main member 32b and the outer circumferential surface 30a. The engagement projection 32c projects from the main member 32b toward a side opposite to the side of the first cylindrical portion 30. The position of the engagement projection 32c is in a middle portion of the main member 32b in the first direction X. In the engagement projection 32c, a front side surface thereof when it is fitted into the first housing 2 is an inclined surface.

The operating portion 32d is connected with the distal end of the main member 32b. The operating portion 32d as viewed in the first direction X has a gate-like shape. More specifically, the operating portion 32d includes a pair of side walls 32f and 32f and a top wall 32g. The side walls 32f and 32f are mutually opposed in the second direction Y. An end portion of each of the side walls 32f in the first direction X is connected with the distal end of the main member 32b. The top wall 32g connects one side wall 32f with the other side wall 32f along the second direction Y. The top wall 32g projects toward the side of the second cylindrical portion 31 beyond the distal end of the main member 32b.

The guide portion 33 has a function of guiding the sensing member 4, a function of locking the sensing member 4 at the temporary locked position, and a function of protecting the operating portion 32d. The guide portion 33 includes a pair of side walls 33a and 33a and a protection wall 33b. Each of the side walls 33a extends along the first direction X from the first cylindrical portion 30 to the second cylindrical portion 31. Each of the side walls 33a projects from the outer circumferential surface 30a of the first cylindrical portion 30 and an outer circumferential surface 31c of the second cylindrical portion 31 in the third direction Z. One side wall 33a is positioned on one side of the second direction Y with respect to the arm 32, and the other side wall 33a is positioned on the other side of the second direction Y with respect to the arm 32. Specifically, the arm 32 is positioned between the side walls 33a and 33a.

Each of the side walls 33a includes a first groove 33c and a second groove 33d. The first groove 33c and the second groove 33d are formed in an opposed surface 33f of each of the side walls 33a. The first groove 33c and the second groove 33d extend along the first direction X, and are arranged side by side in the third direction Z. The first groove 33c is provided with a projection 33e locking the sensing member 4.

The protection wall 33b connects one side wall 33a with the other side wall 33a along the second direction Y. The protection wall 33b is opposed to the top wall 32g of the operating portion 32d in the third direction Z. The protection wall 33b has a columnar or plate shape.

As illustrated in FIG. 9 to FIG. 12, the sensing member 4 includes a main member 40, a first arm 41, a second arm 42, and a piece portion 48. The main member 40, the first arm 41, the second arm 42, and the piece portion 48 are formed of, for example, insulating synthetic resin and as one unitary piece. The main member 40 has a substantially rectangular parallelepiped shape. The main member 40 includes a first surface 40a, an end surface 40b, an opposed surface 40c, a first side surface 40d, a second side surface 40e, and a front surface 40f. The first surface 40a and the opposed surface 40c are surfaces facing a side opposite to the side of the central axis CL of the second housing 3, in a state in which the sensing member 4 is inserted into the second housing 3. In other words, the first surface 40a and the opposed surface 40c are surfaces facing outside in a radial direction orthogonal to the central axis CL. The opposed surface 40c of the present embodiment is substantially orthogonal to the third direction Z.

The end surface 40b is an end surface of the sensing member 4 in the first direction X. The end surface 40b is a pressed surface pressed when the sensing member 4 is inserted into the second housing 3. Specifically, the end surface 40b is a rear end surface at the time when the sensing member 4 is inserted into the second housing 3. The end surface 40b faces a side opposite to the side of the first housing 2, in the state in which the sensing member 4 is inserted into the second housing 3. The end surface 40b of the present embodiment is substantially orthogonal to the first direction X. The piece portion 48 projects from the main member 40 in the third direction Z. A surface of the piece portion 48 connects with the end surface 40b. A distal end of the piece portion 48 has an arc shape corresponding to the outer circumferential surface 31c of the second cylindrical portion 31.

The main member 40 has a shape obtained by chamfering a crossing portion in which the opposed surface 40c and the end surface 40b cross. The first surface 40a is a surface formed by the chamfering. Specifically, the first surface 40a is formed to extend from the opposed surface 40c to the end surface 40b. The first surface 40a extends in a direction inclined with respect to the first direction X. The first surface 40a according to the present embodiment is a flat surface or a substantially flat surface, and parallel with the second direction Y. The first surface 40a includes no depressions or projections that can be visually observed, except a recessed portion 43 described later. The first surface 40a is preferably a smooth surface.

The first side surface 40d and the second side surface 40e are surfaces facing the second direction Y. The first side surface 40d is positioned at one end of the main member 40 in the second direction Y, and the second side surface 40e is positioned at the other end of the main member 40 in the second direction Y. The front surface 40f is a surface on a side opposite to the side of the end surface 40b in the main member 40. The front surface 40f is a surface facing the front side in the insertion direction when the sensing member 4 is inserted into the second housing 3.

The main member 40 includes the recessed portion 43 into which a jig 5 (see FIG. 18) to extract the sensing member 4 is inserted. An opening 43a of the recessed portion 43 is disposed in the first surface 40a. The recessed portion 43 is recessed from the opening 43a along the third direction Z. The width of the opening 43a in the second direction Y is narrowed to prevent a finger of a human hand from entering the recessed portion 43. For example, the width of the opening 43a is narrower than an ordinary width of a fingernail. As described later, the work of extracting the sensing member 4 is executed with the jig 5. A shaft portion 5a of the jig 5 is inserted into the recessed portion 43. The width of the recessed portion 43 is set broader than the width of the shaft portion 5a, and narrower than an ordinary width of a fingernail. For example, in the case where the shaft portion 5a is a flat-bladed driver having a width of 2 mm, the width of the recessed portion 43 may be set to a size of approximately 3 mm. The width of the opening 43a in the first direction X is narrower than the width of the opening 43a in the second direction Y.

The first arm 41 and the second arm 42 project from the front surface 40f of the main member 40 along the first direction X. The first arm 41 is connected with an end portion of the front surface 40f on the first side surface 40d side. The second arm 42 is connected with an end portion of the front surface 40f on the second side surface 40e side. A side surface 41a of the first arm 41 connects with the first side surface 40d of the main member 40. The side surface 41a and the first side surface 40d are provided with a linear rib 41b along the first direction X.

A side surface 42a of the second arm 42 connects with the second side surface 40e of the main member 40. The side surface 42a and the second side surface 40e are provided with a linear rib 42b along the first direction X. The ribs 41b and 42b are guided with the second grooves 33d of the second housing 3. The first arm 41 includes a projection 41c projecting from the side surface 41a in the second direction Y. The projection 41c is positioned on the distal end side of the first arm 41 beyond the rib 41b. The second arm 42 includes a projection 42c projecting from the side surface 42a in the second direction Y. The projection 42c is positioned on the distal end side of the second arm 42 beyond the rib 42b. The projections 41c and 42c are guided with the first grooves 33c of the second housing 3 along the first direction X. The projections 41c and 42c are locked with the projections 33e provided in the first grooves 33c.

As illustrated in FIG. 11 and FIG. 12, a distal end portion of each of the first arm 41 and the second arm 42 is provided with an abutment portion 44 and a raised portion 45. The abutment portion 44 and the raised portion 45 are adjacent to each other in the second direction Y. The abutment portion 44 and the raised portion 45 project in the third direction Z. The abutment portion 44 includes an abutment surface 44a. The abutment surface 44a serves as a distal end surface of each of the first arm 41 and the second arm 42. The abutment surface 44a is substantially orthogonal to the first direction X. The sensing member 4 is inserted into the second housing 3, with the abutment surface 44a facing the front side.

As illustrated in FIG. 11, the raised portion 45 in a side view has a substantially triangular shape. The raised portion 45 has a tapered shape having a width in the first direction X narrowed toward the distal end in the projecting direction. The raised portion 45 includes a first inclined surface 45a and a second inclined surface 45b. The first inclined surface 45a is positioned on the distal end side of the first arm 41 and the second arm 42 with respect to a vertex 45c of the raised portion 45. The second inclined surface 45b is positioned on a proximal end side of the first arm 41 and the second arm 42 with respect to the vertex 45c. The first inclined surface 45a and the second inclined surface 45b are inclined with respect to the first direction X.

As illustrated in FIG. 13, the sensing member 4 is inserted into the second housing 3 along the first direction X. The sensing member 4 is inserted between the side walls 33a and 33a of the guide portion 33. The ribs 41b and 42b of the sensing member 4 is inserted into the second grooves 33d, and guided in the first direction X with the second grooves 33d. The projections 41c and 42c are inserted into the first grooves 33c, and guided in the first direction X with the first grooves 33c.

The sensing member 4 is inserted into the second housing 3 to a predetermined temporary locked position. FIG. 14 illustrates the sensing member 4 locked at the temporary locked position. As illustrated in FIG. 14, the abutment surfaces 44a of the first arm 41 and the second arm 42 are opposed to the locking portions 34 of the second housing 3 in the first direction X. When the sensing member 4 in the temporary locked position is pressed in a pushing direction Xin, the abutment surfaces 44a abut against the locking portions 34. Specifically, the locking portions 34 lock the sensing member 4 at the temporary locked position.

The projection 41c of the first arm 41 is moved over the projection 33e, and locked with the projection 33e. The projection 33e regulates movement of the sensing member 4 in an extraction direction Xout, and stops the sensing member 4 at the temporary locked position. After the sensing member 4 is inserted to the temporary locked position, the second housing 3 is fitted into the first housing 2.

FIG. 15 illustrates a cross section in the middle of fitting. More specifically, FIG. 15 illustrates a state in which the raised portion 45 of the sensing member 4 contacts the guide projection 23b of the first housing 2. The first inclined surface 45a of the raised portion 45 contacts the distal end of the guide projection 23b. From this state, as illustrated with an arrow A1, the second housing 3 and the sensing member 4 are pushed along the first direction X. In this manner, as illustrated with an arrow A2, the guide projections 23b deflect and deform the first arm 41 and the second arm 42 in the third direction Z. By deflective deformation of the first arm 41 and the second arm 42, the raised portions 45 run on the guide projections 23b.

When the first housing 2 and the second housing 3 are completely fitted, the vertexes 45c of the respective raised portions 45 run on the guide projections 23b. As a result, the abutment portions 44 are enabled to pass over the locking portions 34. Accordingly, when the worker pushes the sensing member 4 along the first direction X, the sensing member 4 is inserted to the engaged position. By contrast, when the first housing 2 and the second housing 3 are not completely fitted, the state in which the locking portions 34 are opposed to the abutment surfaces 44a in the first direction X is maintained. For this reason, even when the worker attempts to push the sensing member 4, the pushing is regulated with the locking portions 34.

As described above, the guide projections 23b, the locking portions 34, and the raised portions 45 form a sensing mechanism 50. The sensing mechanism 50 allows the sensing member 4 to advance to the engaged position when the first housing 2 and the second housing 3 are completely fitted. In addition, the sensing mechanism 50 locks the sensing member 4 at the temporary locked position before the engaged position when the first housing 2 and the second housing 3 are not completely fitted.

FIG. 16 illustrates the sensing member 4 in the engaged position. When the first housing 2 and the second housing 3 are completely fitted, the engagement projection 32c of the second housing 3 is engaged with the engagement hole 20d of the first housing 2. This engagement regulates relative movement of the first housing 2 and the second housing 3 along the first direction X. Specifically, in the complete fitted state, the first housing 2 and the second housing 3 are locked. When the sensing member 4 is inserted to the engaged position, the abutment portions 44 and the raised portions 45 of the sensing member 4 are positioned on a side deeper than the locking portions 34.

As illustrated in FIG. 17, in the engaged position, the projection 42c of the second arm 42 is locked with the projection 33e of the second housing 3. The projection 33e locks the projection 42c, and regulates movement of the sensing member 4 toward the extraction direction Xout.

As illustrated in FIG. 16, the main member 40 of the sensing member 4 enters the space between the operating portion 32d and the outer circumferential surface 31c. In this manner, when the pressing force toward the outer circumferential surface 31c acts on the operating portion 32d, the main member 40 locks the operating portion 32d and regulates deflective deformation of the arm 32. Specifically, the sensing member 4 in the engaged position disables a lock release operation, and maintains the complete fitted state of the first housing 2 and the second housing 3.

When the sensing member 4 is extracted from the engaged position, the jig 5 is used as illustrated in FIG. 18. The jig 5 is, for example, a flat-bladed driver, and includes an elongated shaft portion 5a. The shaft portion 5a is inserted into the recessed portion 43 of the sensing member 4. The worker applies force F1 in the extraction direction Xout to the sensing member 4 via the jig 5. By action of the force F1, the projection 42c of the second arm 42 is moved over the projection 33e of the second housing 3. In addition, the raised portions 45 of the first arm 41 and the second arm 42 are moved over the guide projections 23b, and the abutment portions 44 are moved over the locking portions 34. In this manner, the sensing member 4 is enabled to move from the engaged position to the temporary locked position. Movement of the sensing member 4 to the temporary locked position enables a lock release operation of pressing down the operating portion 32d.

As explained hereinafter, the connector 1 according to the present embodiment is configured such that extracting the sensing member 4 with human fingers without using the jig 5 is substantially impossible or extremely difficult. As illustrated in FIG. 16, in the connector 1 according to the present embodiment, when the sensing member 4 is in the engaged position, part of the sensing member 4 is exposed to the outer space. In the following explanation, in the main member 40 of the sensing member 4, a portion covered with the second housing 3 when the sensing member 4 is in the engaged position is referred to as “stored portion 46”. In the main member 40, a portion exposed to the outer space when the sensing member 4 is in the engaged position is referred to as “exposed portion 47”.

The stored portion 46 is a portion including the opposed surface 40c. The exposed portion 47 is a portion including the first surface 40a and the end surface 40b. In the sensing member 4 according to the present embodiment, the boundary between the stored portion 46 and the exposed portion 47 is a portion in which the first surface 40a and the opposed surface 40c cross.

As illustrated in FIG. 16, in the third direction Z, the stored portion 46 is stored between the operating portion 32d of the arm 32 and the outer circumferential surface 31c of the second cylindrical portion 31. In addition, as illustrated in FIG. 18 and FIG. 19, the stored portion 46 is stored between the side walls 33a and 33a in the second direction Y. The space between each of the side walls 33a and the operating portion 32d in the second direction Y is narrow to such a degree that the space does not allow insertion of a human finger. In addition, the space between each of the side wall portions 33a and 33a and the main member 40 is extremely narrow. For this reason, even when the opposed surface 40c has a difference in level, the structure prevents access of the worker's fingers or nails to the difference in level. In the sensing member 4 in the engaged position, a portion that can be touched with the fingers is substantially only the exposed portion 47. In addition, in the exposed portion 47, a surface that can be touched with the fingers is the first surface 40a or the end surface 40b.

In addition, in the exposed portion 47, the surface to which force in the extraction direction Xout can be applied to the main member 40 with the fingers is the first surface 40a. The first surface 40a is a surface facing a side opposite to the central axis CL of the second housing 3, in other words, a surface facing the outside of the second housing 3. The first surface 40a according to the present embodiment is an inclined surface extending in a direction inclined with respect to the first direction X, as illustrated in FIG. 20. The first surface 40a is inclined with respect to the first direction X with an inclination angle θ. The first surface 40a is inclined to approach the outer circumferential surface 31c as it extends away from the operating portion 32d along the first direction X.

When the worker attempts to extract the sensing member 4 with his/her fingers, the worker is required to cause frictional force F2 to act, as illustrated in FIG. 20. In the extraction, the worker is required to press the first surface 40a by pressing force F3 corresponding to the frictional force F2. The magnitude of the required pressing force F3 depends on a friction coefficient μ between a finger and the first surface 40a, for example, a static friction coefficient. Component force F2x of the frictional force F2 along the first direction X is force in a direction of extracting the sensing member 4. By contrast, component force F3x of the pressing force F3 along the first direction X is force of pushing the sensing member 4. Specifically, the force acting on the sensing member 4 in the first direction X is resultant force Fx of the component force F2x and the component force F3x. When the resultant force Fx is directed in the extraction direction Xout, the force in the extraction direction Xout acts on the sensing member 4. By contrast, when the resultant force Fx is directed in the pushing direction Xin, the force in the pushing direction Xin acts on the sensing member 4.

The inclination angle θ is determined such that, for example, the resultant force Fx is directed in the pushing direction Xin with respect to the assumed friction coefficient μ1. The value of the friction coefficient μ1 is, for example, a value of an ordinary friction coefficient μ between a finger of the worker and the first surface 40a in the case where the worker touches the first surface 40a with a bare hand. The value of the friction coefficient μ1 may be a value of an ordinary friction coefficient μ between the glove put on the worker's hand and the first surface 40a. The roughness of the first surface 40a may be set to set the friction coefficient μ to a desired value or less.

The inclination angle θ may be set to, for example, 45° or more. In the case where the inclination angle θ is set to 45° or more, the resultant force Fx is set to force in the pushing direction Xin when the value of the friction coefficient μ is smaller than 1. The inclination angle θ may be set to an angle larger than 45°. In this case, even when the value of the friction coefficient μ is 1, the resultant force Fx is set to force in the pushing direction Xin. With the resultant force Fx set to the force in the pushing direction Xin with respect to the ordinarily assumed value of the friction coefficient μ, extraction of the sensing member 4 with the fingers is substantially disabled.

In addition, the connector 1 according to the present embodiment is configured such that it is difficult for the worker to use the recessed portion 43 to apply a force in the extraction direction Xout. For example, the opening 43a of the recessed portion 43 is disposed on the inclined first surface 40a. This structure causes difficulty in putting a finger or nail into the recessed portion 43. In addition, the opening 43a is chamfered to have an arc-shaped cross section. In other words, a portion in which the recessed portion 43 and the first surface 40a cross has a chamfered shape with rounded corners. This structure suppresses putting of a finger or nail into the opening 43a. With this structure, it is difficult for the worker to use the recessed portion 43 to apply a force to the sensing member 4 in the extraction direction Xout.

In addition, as illustrated in FIG. 19 and the like, the opening 43a is disposed in an end portion of the first surface 40a in the second direction Y. The opening 43a is adjacent to the side wall 33a. This structure causes difficult in putting a finger or nail into the opening 43a. This structure substantially disables extraction of the sensing member 4 with the fingers.

As described above, the connector 1 according to the present embodiment includes the first housing 2, the second housing 3, the sensing member 4, and the sensing mechanism 50. The second housing 3 is fitted into the first housing 2 along the first direction X. The sensing member 4 is inserted into the second housing 3 along the first direction X. The sensing mechanism 50 allows the sensing member to advance to the engaged position along the first direction X when the first housing 2 and the second housing 3 are completely fitted. By contrast, the sensing mechanism 50 locks the sensing member 4 at the temporary locked position before the engaged position when the first housing 2 and the second housing 3 are not completely fitted.

The sensing member 4 includes the exposed portion 47 positioned in an end portion of the sensing member 4 and exposed to the outer space when the sensing member 4 is in the engaged position. In the exposed portion 47, the first surface 40a exposed to a side opposite to the side of the central axis CL of the second housing 3 is an inclined surface extending in a direction inclined with respect to the first direction X. The first surface 40a faces a side opposite to the first housing 2 in the first direction X. With this structure, the connector 1 according to the present embodiment enables a structure in which the sensing member 4 cannot be extracted with the fingers.

The sensing member 4 according to the present embodiment includes the stored portion 46 covered with the second housing 3 when the sensing member 4 is in the engaged position. The exposed portion 47 includes the end surface 40b orthogonal to the first direction X. The first surface 40a connects the end surface 40b with the stored portion 46. This structure enables restriction of the surface that can be touched by the worker who attempts to release the sensing member 4 with his/her fingers to the first surface 40a.

In the connector 1 according to the present embodiment, the inclination angle θ of the first surface 40a with respect to the first direction X is an angle setting the direction of the resultant force Fx acting on the sensing member 4 in the first direction X to the pushing direction Xin when the frictional force F2 in the direction of extracting the sensing member 4 with human fingers is applied to the first surface 40a. Setting the inclination angle θ like this dynamically disables release of the sensing member 4 with the fingers.

The inclination angle θ of the first surface 40 a with respect to the first direction X may be set to 45° or more. In this case, when the value of the friction coefficient μ between a finger and the first surface 40a is smaller than 1, the resultant force Fx is set to the force in the pushing direction Xin. This structure dynamically disables release of the sensing member 4 with the fingers.

The second housing 3 according to the present embodiment includes an arm 32 extending along the first direction X and engaged with the first housing 2 when the first housing 2 and the second housing 3 are completely fitted. The arm 32 exposes the exposed portion 47 and covers the stored portion 46 adjacent to the exposed portion 47 when the sensing member 4 is in the engaged position. Covering the stored portion 46 with the arm 32 disables a touch with the hand on a portion other than the exposed portion 47.

The sensing member 4 according to the present embodiment includes the recessed portion 43 into which the jig 5 to extract the sensing member 4 is inserted. The recessed portion 43 is opened to the first surface 40a. The recessed portion 43 opened to the inclined first surface 40a enables the structure in which a release operation with the fingers using the recessed portion 43 is difficult.

In the recessed portion 43 according to the present embodiment, a portion in which the recessed portion 43 and the first surface 40a cross has a chamfered shape with rounded corners. This structure enables difficulty in putting a finger or nail into the opening 43a.

### Modification of Embodiment

The shape of the first surface 40a is not limited to a flat surface. For example, the first surface 40a may be a curved surface having an arc-shaped cross section. When the first surface 40a is a curved surface, the first surface 40a may be curved in a convex manner or in a concave manner.

The opening 43a of the recessed portion 43 may be disposed in a position different from the first surface 40a. For example, the recessed portion 43 may be disposed in the opposed surface 40c. The means for extracting the sensing member 4 from the engaged position is not limited to a combination of the recessed portion 43 and the illustrated jig 5. For example, when the sensing member 4 is extracted from the engaged position, a tool different from the illustrated jig 5 may be used.

The details disclosed in the embodiment and the modification described above may be carried out in proper combinations.

The sensing member of the connector according to the embodiment invention includes the exposed portion exposed to the outer space when the sensing member is in the engaged position. In the exposed portion, the first surface exposed to a side opposite to the side of the central axis of the second housing is an inclined surface or an arc-shaped surface extending in a direction inclined with respect to the first direction and facing a side opposite to the side of the first housing in the first direction. The connector according to the embodiment invention produces the effect of achieving the structure in which the sensing member cannot be extracted with the fingers because the first surface is a surface inclined with respect to the first direction.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a first housing;
a second housing that is fitted into the first housing along a first direction;
a sensing member that is inserted into the second housing along the first direction; and
a sensing mechanism that allows the sensing member to advance to a predetermined engaged position along the first direction when the first housing and the second housing are completely fitted, and locking the sensing member at a position before the engaged position when the first housing and the second housing are not completely fitted, wherein
the sensing member includes an exposed portion positioned in an end portion of the sensing member and exposed to an outer space when the sensing member is in the engaged position, and
in the exposed portion, a first surface exposed to a side opposite to a side of a central axis of the second housing is an inclined surface or an arc-shaped surface extending in a direction inclined with respect to the first direction and facing a side opposite to a side of the first housing in the first direction.

2. The connector according to claim 1, wherein
the sensing member includes a stored portion covered with the second housing when the sensing member is in the engaged position,
the exposed portion includes an end surface orthogonal to the first direction, and
the first surface connects the end surface with the stored portion.

3. The connector according to claim 1, wherein
an inclination angle of the first surface with respect to the first direction is an angle setting a direction of resultant force acting on the sensing member in the first direction to a direction in which the sensing member is pushed, when frictional force in a direction of extracting the sensing member with a human finger is applied to the first surface.

4. The connector according to claim 2, wherein
an inclination angle of the first surface with respect to the first direction is an angle setting a direction of resultant force acting on the sensing member in the first direction to a direction in which the sensing member is pushed, when frictional force in a direction of extracting the sensing member with a human finger is applied to the first surface.

5. The connector according to claim 1, wherein
the inclination angle of the first surface with respect to the first direction is 45° or more.

6. The connector according to claim 2, wherein
the inclination angle of the first surface with respect to the first direction is 45° or more.

7. The connector according to claim 1, wherein
the second housing includes an arm extending along the first direction and engaged with the first housing when the first housing and the second housing are completely fitted, and
the arm exposes the exposed portion and covers a portion adjacent to the exposed portion when the sensing member is in the engaged position.

8. The connector according to claim 2, wherein
the second housing includes an arm extending along the first direction and engaged with the first housing when the first housing and the second housing are completely fitted, and
the arm exposes the exposed portion and covers a portion adjacent to the exposed portion when the sensing member is in the engaged position.

9. The connector according to claim 3, wherein
the second housing includes an arm extending along the first direction and engaged with the first housing when the first housing and the second housing are completely fitted, and
the arm exposes the exposed portion and covers a portion adjacent to the exposed portion when the sensing member is in the engaged position.

10. The connector according to claim 5, wherein
the second housing includes an arm extending along the first direction and engaged with the first housing when the first housing and the second housing are completely fitted, and
the arm exposes the exposed portion and covers a portion adjacent to the exposed portion when the sensing member is in the engaged position.

11. The connector according to claim 1, wherein
the sensing member includes a recessed portion into which a jig to extract the sensing member is inserted, and
the recessed portion is opened to the first surface.

12. The connector according to claim 2, wherein
the sensing member includes a recessed portion into which a jig to extract the sensing member is inserted, and
the recessed portion is opened to the first surface.

13. The connector according to claim 3, wherein
the sensing member includes a recessed portion into which a jig to extract the sensing member is inserted, and
the recessed portion is opened to the first surface.

14. The connector according to claim 5, wherein
the sensing member includes a recessed portion into which a jig to extract the sensing member is inserted, and
the recessed portion is opened to the first surface.

15. The connector according to claim 7, wherein
the sensing member includes a recessed portion into which a jig to extract the sensing member is inserted, and
the recessed portion is opened to the first surface.

16. The connector according to claim 11, wherein
in an opening of the recessed portion, a portion in which the recessed portion and the first surface cross has a chamfered shape with rounded corners.
